(19) United States
(12) Patent Application Publication
(10) Pub. No.: US 2005/0022663 A1
(43) Pub. Date: Feb. 3, 2005

(54) Method for protecting pump components

(76) Inventor: Michael Brent Ford, St. George, UT (US)

Correspondence Address: WEISS & MOY PC, 4204 NORTH BROWN AVENUE, SCOTTSDALE, AZ, 85251, US

(21) Appl. No.: 10/630,964

(22) Filed: Jul. 30, 2003

(51) Int. Cl. F16J 10/00

(52) U.S. Cl. 92/169.1

(57) ABSTRACT

A method for protecting pump components by coating moving components with an amorphous carbon material. Components that preferably receive such coating include the plunger, barrel, travelling valve ball and seat, and standing valve ball and seat. Other components may also be coated. The coating thickness is preferably in the range of between about 0.0002″ and 0.0008″.

### FIELD OF THE INVENTION

The present invention relates generally to pumping systems and, more specifically, to a method for reducing wear and tear on pumping system components.

### BACKGROUND OF THE INVENTION

During down-hole pumping operations, various pumping components are subject to wear and tear caused by repeated sliding or other movement that involves contact with another component. For example, repeated movement of the ball relative to the seat (in each of the travelling valve and standing valve) causes wear to both of these components. Rubbing of the plunger against the barrel, during up and down movement of the plunger relative to the barrel, is similarly wearing. In general, pump components that are in sliding or other moving relationship to each other are subject to friction-caused wear and tear.

To impart resistance to friction-caused wear and tear, prior art components are chromed, coated with nickel carbide, or hardened. This provides some limited protection, but improved protection, and thus longer life for pump components, is desired.

The present invention satisfies this need and provides other, related, applications.

### SUMMARY OF THE INVENTION

It is an object of the present invention to provide a method for reducing friction-caused wear and tear on pump components.

It is a further object of the present invention to provide a method for reducing friction-caused wear and tear on pump components through a method of coating such components with an improved protective coating material.

### DETAILED DESCRIPTION OF THE PREFERRED EMBODIMENTS

Initially, some of the basic moving components of an oil pumping system should be noted. Such components include a plunger, which travels within a barrel. The barrel is itself received within tubing. It further includes a traveling valve, which is opened and closed by movement of a ball that is received within a seat. Yet further, the apparatus will typically include a standing valve, which is similarly activated by movement of a ball that is received within a seat.

According to the method of the present invention, it will be desired to coat pump components that are subject to friction-caused wear and tear with a protective coating. The protective coating should be amorphous carbon which, when applied, will have a Rockwell hardness in the range of 90 or greater. This will impart a ceramic like hardness to the applied surface. The thickness of the applied coating should be maintained within the range of between about 0.0002″ and 0.0008″. Amorphous carbon of the type preferred for use as described herein is available from Armoloy of Illinois, located in DeKalb Ill.

Testing has shown that an amorphous carbon coating to pump components becomes integral with the base metal, and does not chip or peel during bending impact and normal operational flexing. It can operate successfully at temperatures up to about 1400 Fahrenheit with no adverse effects on either the coating or on base metal integrity. The coating greatly reduces surface friction between sliding and mating components, as compared to prior art methods, and eases assembly and disassembly. It further provides substantial anti-galling and anti-fretting corrosion protection.

Amorphous carbon may be applied to a variety of pump components that are vulnerable to friction-caused wear and tear. It is preferred, in particular, to apply it to balls, seats, plungers, and barrels. Other components may be coated as well, including valve rods, valve-rod bushings, threads, gears, bearings, the PC pump-rotor, and chokes.

Preferably, components that are involved in friction-caused wear and tear with each other are both coated. For example, both a travelling valve ball and travelling valve seat should each be coated as described herein. However, the coating of even one of two components that slide or otherwise move relative to each other should confer some of the benefits described herein.

It should be noted that it may be desired to blend the amorphous carbon with chrome, and to thereby apply a mixed coating to the pump components.

While the invention has been particularly shown and described with reference to preferred embodiments thereof, it will be understood by those skilled in the art that the foregoing and other changes in form and details may be made therein without departing from the spirit and scope of the invention.

1. A method for reducing wear and tear on components in an oil-pumping system, comprising the steps of:
providing a first component of an oil pumping system;
providing a second component of an oil pumping system that is in moving contact with said first component during operation of said oil-pumping system, such that said moving contact tends to cause wear and tear on at least one of said first component and said second component over time;
coating at least one of said first component and said second component with amorphous carbon.

2. The method of claim 1 further comprising the step of coating each of said first component and said second component with amorphous carbon.

3. The method of claim 1 wherein said coating step involves application of an amorphous carbon coating having a thickness within the range of between about 0.0002″ and 0.0008″.

4. The method of claim 1 wherein said first component is a ball.

5. The method of claim 4 wherein said second component is a seat.

6. The method of claim 1 wherein said first component is a plunger.

7. The method of claim 6 wherein said second component is a barrel.

8. A method for reducing wear and tear on components in an oil-pumping system, comprising the steps of:
providing an oil pumping system including a travelling valve ball, a travelling valve seat, a standing valve ball, a standing valve seat, a plunger and a barrel; and
coating each of said travelling valve ball, travelling valve seat, standing valve ball, standing valve seat, plunger and barrel with amorphous carbon.

9. The method of claim 8 wherein said coating step involves application of an amorphous carbon coating having a thickness within the range of between about 0.0002″ and 0.0008″.
